(19) United States
(12) Patent Application Publication
(10) Pub. No.: US 2010/0254456 A1
(43) Pub. Date: Oct. 7, 2010

(54) DEVICE AND METHOD OF ENCODING MOVING IMAGE

(76) Inventors: Takaki MATSUSHITA, Yokohama (JP); Hiroki Mizosoe, Kawasaki (JP); Bondan Setiawan, Yamato (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/749,695

(22) Filed: Mar. 30, 2010

(30) Foreign Application Priority Data
Apr. 6, 2009 (JP) 2009-092009

(51) Int. Cl. H04N 7/26; H04N 7/32

(52) U.S. Cl. 375/240.12; 375/240.01; 375/E07.243

(57) ABSTRACT

An encoding device is a device for encoding a moving image and includes: an imaging unit that shoots a subject; an encoder circuit that encodes an input moving image; a stream buffer that accumulates the encoded data; a network circuit that transmits the encoded data in the stream buffer to a network; and a read position skipping unit that, when an accumulated amount of the accumulated data, which has been accumulated in the stream buffer, is greater than or equal to a threshold value, transmits the encoded data to the network after advancing a read position at which the encoded data is to be read to, for example, the head position of the latest I-picture.

### INCORPORATION BY REFERENCE

This application relates to and claims priority from Japanese Patent Application No. 2009-092009 filed on Apr. 6, 2009, the entire disclosure of which is incorporated herein by reference.

### BACKGROUND OF THE INVENTION

(1) Field of the Invention

The present invention relates to a device and a method of encoding a moving image, and in particular, to a device and a method of encoding a moving image by which a delay or an underflow of data may be prevented when used in a real-time video and audio communication system, such as a TV (television) phone and teleconference.

(2) Description of the Related Art

In recent years, video and audio communication devices, such as TV phones and teleconference, have become popular with the development of the video encoding technique and communication lines. In addition, a function has been mounted on mobile products, such as mobile phones, whereby real-time video and audio communication may be accomplished.

On the other hand, with the development of the imaging technique and the encoding technique, cameras by which HD (High Definition) video may be shot have been put on the market, and the real-time video and audio communication system with HD video quality is also expected. However, there is a problem in the real-time video and audio communication system using HD video that a delay between two places is increased because of an increase in data amount, therefore the communication between both sides cannot be continued smoothly.

As a device for encoding a moving image by which the aforementioned delay in the video and audio communication may be reduced, the devices disclosed in Japanese Patent Application Laid-Open H7 (1995)-193821 and Japanese Patent Application Laid-Open 2006-80788 may be cited.

In the device disclosed in the former Patent Document, a delay is reduced by clearing the data in a transmission buffer when the transmission side receives a screen update request that has been issued if a decoding error is detected on the reception side. In addition, with the input moving image, immediately after the aforementioned processing, being intra-encoded by intra-frame processing, it is prevented that a decoding error may again occur on the reception side.

In the device disclosed in the latter Patent Document, a delay is reduced by only the transmission side with the use of an easier logic. That is, data in a transmission buffer, which is being monitored, are cleared after an input moving image is intra-encoded when a certain amount or more of data are accumulated in the transmission buffer. Thereby, a delay may be reduced and a decoding error may be prevented from occurring on the reception side.

### SUMMARY OF THE INVENTION

A delay may be reduced and a decoding error may be eliminated on the reception side by the techniques disclosed in the aforementioned Patent Documents.

However, in the former Patent Document, minimum encoded data, necessary for transmission, have to be stored in the transmission buffer after predicting the period required from when the encoded data are cleared to when the encoded data of the next moving image is completed. In this case, because accurate prediction of the timing when the encoded data in the transmission buffer will be transmitted is difficult, there is a possibility that an underflow in the transmission buffer may occur due to the difference between the optimal value and the real value of the remaining amount of the encoded data in the transmission buffer.

Also, in the latter Patent Document the timing of reducing a delay is sometimes delayed because the data to be transmitted are cleared after the intra-encoding is completed.

In addition, when video and audio communication is generally performed, video and audio are multiplexed into the formats, such as the TS (Transport Stream) format and the PS (Program Stream) format. In both the aforementioned Patent Documents, the boundary between picture units (I-picture; Intra Picture, P-picture; Predictive Picture, B-picture; Bi-directionally Predictive Picture) is taken into consideration; however, the data in the transmission buffer are cleared without consideration of the packet boundary between the MPEG (Moving Picture Experts Group) system layers, such as TS and PS. Therefore, the packet boundary between receiving streams may be shifted depending on a decoding device on the reception side, thereby possibly causing a decoding error.

In view of the aforementioned circumstances, an object of the present invention is to provide a device and a method of encoding a moving image by which a delay may be reduced and an underflow of data may be prevented. Another object of the invention is to provide a device and a method of encoding a moving image by which a decoding error is made less likely to occur in accordance with the constraint of the decodable input format in a moving image decoding device on the reception side.

In order to achieve these objects, the present invention relates to a device for encoding a moving image. The device for encoding a moving image comprises: an imaging unit that generates the moving image by shooting a subject; an encoder circuit that encodes data of the moving image; a stream buffer that accumulates the encoded data of the moving image that is supplied from the encoder circuit; a network circuit that transmits the encoded data of the moving image, which has been accumulated in the stream buffer, to a network; and a system controller that operatively controls the device for encoding a moving image, wherein, when an accumulated amount of the encoded data, which has been accumulated in the stream buffer, is greater than or equal to a predetermined threshold value, the system controller controls the device for encoding a moving image such that a read position at which the encoded data is to be read from the stream buffer is advanced forward on the time axis.

Further, the present invention relates to a method of encoding a moving image. The method of encoding a moving image comprises: an imaging step that creates the moving image by shooting a subject; an encoding step that encodes data of the moving image; an accumulation step that accumulates the encoded data of the moving image that has been created in the encoding step; a communication step that transmits the encoded data of the moving image, which has been accumulated in the accumulation step, to a network; and a system control step that controls the encoding step, the accumulation step, and the communication step, wherein the system control step includes an accumulated amount determination step that determines whether an accumulated amount of the encoded data of the moving image, which has been accumulated in the accumulation step, is greater than or equal to a predetermined threshold value, and wherein, when it is determined that an accumulated amount of the encoded data of the moving image, which has been accumulated in the accumulation step, is greater than or equal to a predetermined threshold value as a result of the determination in the accumulated amount determination step, the system control step controls the accumulation step such that a read position at which the encoded data is to be read from the accumulation step is advanced forward on the time axis.

According to the present invention, a device and a method of encoding a moving image by which a delay is reduced may be provided. In an embodiment of the invention, a device and a method of encoding a moving image by which an underflow of data is prevented may be provided. In another embodiment of the invention, a device and a method of encoding a moving image by which a decoding error is made less likely to occur in a moving image decoding device on the reception side may be provided. There is an effect in any case that a TV phone system or a TV conference system may be improved in terms of usability.

### BRIEF DESCRIPTION OF THE DRAWINGS

These and other features, objects and advantages of the present invention will become more apparent from the following description when taken in conjunction with the accompanying drawings wherein:

FIG. 1 is a view illustrating a hardware structure of an encoding device according to an embodiment of the present invention;

FIG. 2 illustrates the whole flow chart in an encoding device according to Embodiment 1;

FIG. 3 illustrates a flowchart with respect to an encoding step in the encoding device according to Embodiment 1;

FIG. 4 illustrates a flow chart with respect to a network transmission step in the encoding device according to Embodiment 1;

FIG. 5 illustrates a flow chart with respect to a network transmission step in an encoding device according to Embodiment 2;

FIG. 6 illustrates a method of calculating a correction size in the encoding device according to Embodiment 2;

FIG. 7A is a conceptual view of an Open GOP;

FIG. 7B is a conceptual view of a Closed GOP;

FIG. 8 illustrates a flow chart with respect to a network transmission step in an encoding device according to Embodiment 3;

FIG. 9 illustrates a flow chart with respect to an encoding step in an encoding device according to Embodiment 4; and

FIG. 10 illustrates a flow chart with respect to a network transmission step in the encoding device according to Embodiment 4.

### DETAILED DESCRIPTION OF THE EMBODIMENT

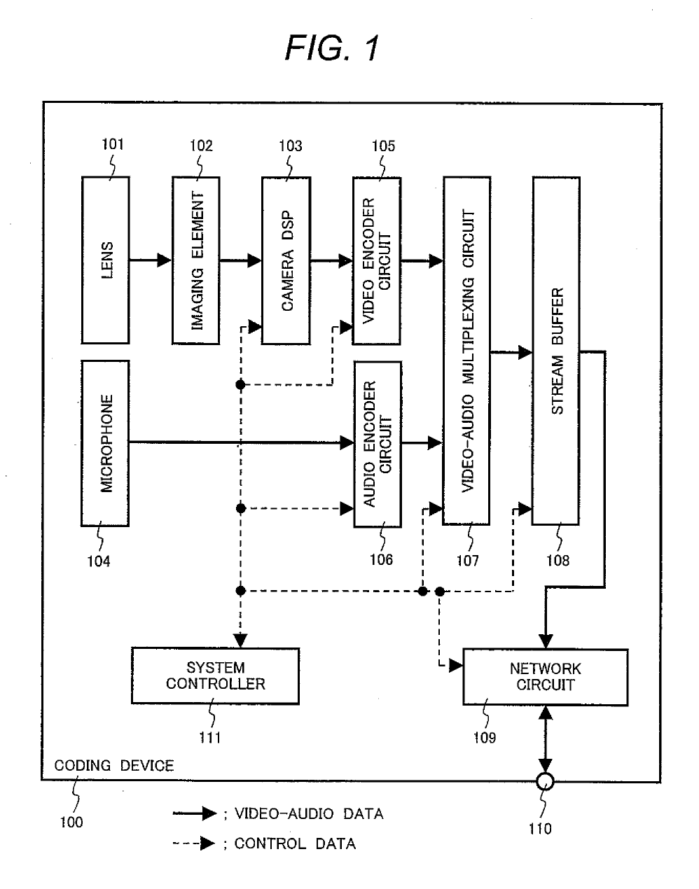

Hereinafter, embodiments of the present invention will be described in detail with reference to the accompanying FIGS. 1 through 10.

FIG. 1 is a view illustrating a hardware structure of an encoding device 100 according to an embodiment of the present invention. The hardware structure is applicable to Embodiments 1 through 4, which will be described later. As illustrated in FIG. 1, the encoding device 100 comprises a lens 101, an imaging element 102, a camera DSP (Digital Signal Processor) 103, a microphone 104, a video encoder circuit 105, an audio encoder circuit 106, a video-audio multiplexing circuit 107, a stream buffer 108, a network circuit 109, a communication I/O (input/output) terminal 110, and a system controller 111.

In the real-time video and audio communication, a start request is issued by a decoding device, which is located remotely, and an encoding device initiates the processing after receiving the request. In the encoding device 100 that transmits video, an optical signal, which has been inputted from the lens 101, is at first converted into an electrical signal by the imaging element 102 and then the analog electrical signal is converted into a digital signal. The camera DSP 103 converts a video signal, which has been inputted from the imaging element 102, into a format that may be inputted to the video encoder circuit 105. An audio input signal from the microphone 104 is inputted to the audio encoder circuit 106. The video elementary stream encoded by the video encoder circuit 105 and the audio elementary stream encoded by the audio encoder circuit 106 are packetized by the video-audio multiplexing circuit 107 into a format, such as the TS format or the PS format, and then accumulated in the stream buffer 108. The network circuit 109 is one for communicating with an external apparatus, and transmits the contents accumulated in the stream buffer 108 to a network. Communication with an external apparatus may be performed through the I/O terminal 110 and a network such as the Internet. The system controller 111 controls the whole system of the encoding device 100. Specifically, by controlling the camera DSP 103, the video encoder circuit 105, the audio encoder circuit 106, the video-audio multiplexing circuit 107, the stream buffer 108, and the network circuit 109, the processing on the transmission side of a real-time video and audio communication system is executed.

The stream buffer 108 accumulates the packetized stream by using a RAM (Random Access Memory). Although the network circuit 109 may be one for wireless communication or wired communication, the communication I/O terminal 110 may be omitted in the case of wireless communication. Data to be transmitted or received are video-audio streams but other various commands, such as a file transfer protocol, may be transmitted or received. The system controller 111 is structured mainly with a CPU (Central Processing Unit) and a flash memory, and the program beforehand stored in the flash memory is loaded and executed by the CPU.

### Embodiment 1

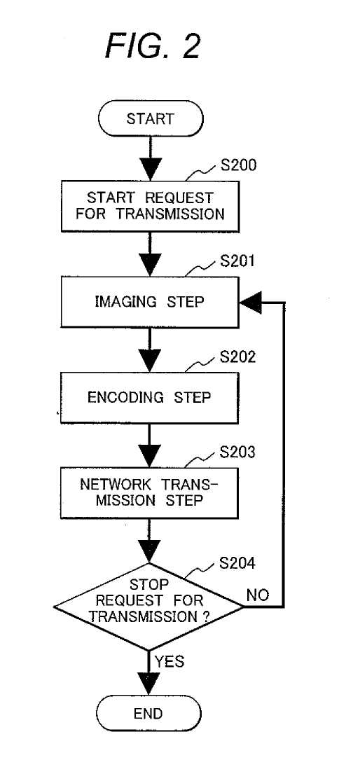

An embodiment of the present invention will be described with reference to FIGS. 2 through 4. FIG. 2 illustrates the whole flow chart in an encoding device according to the present embodiment, the whole flow chart covering the encoding step through the network transmission step. In Step S200, the network circuit 109 of the encoding device 100 receives a start request for transmission, which has been issued from a decoding device that is located remotely. Upon receiving the start request for transmission, the system controller 111 controls each of the aforementioned components in accordance with the start request so that the imaging step of Step 201 is executed. The encoding device 100 shoots a moving image to be encoded and inputs the moving image to the video encoder circuit 105. Specifically, in the imaging step S201, the optical signal, which has been imported by the lens 101, is converted into an electrical signal by the imaging element 102. The converted electrical signal is converted by the camera DSP 103 into a format that may be inputted to the video encoder circuit 105 and then supplied thereto. The audio data picked up by the microphone 104 is also supplied to the audio encoder circuit 106.

Subsequently, the input moving image and the input audio, which have been created in the imaging step S201, are encoded in the encoding step of Step S202. As a type of encoding video, MPEG 2 (ISO/IEC 13818), MPEG 4 AVC/H. 264 (ISO/IEC 14496 10), etc., are used. As a type of encoding audio, AAC (Advanced Audio Coding), AC 3 (Dolby Digital Audio Code number 3), etc., are used. However, en encoding method other than the aforementioned methods may be used if the encoding method is supported by the decoding device on the side that has issued the request. Specifically, the video data encoded by the video encoder circuit 105 and the audio date encoded by the audio encoder circuit 106 are accumulated in the stream buffer 108 after being multiplexed by the video-audio multiplexing circuit 107.

When the encoding step S202 has ended, the network transmission step of Step S203 is executed. In the network transmission step S203, the encoded stream, which has been accumulated in the stream buffer 108, is transmitted to the decoding device (not illustrated) by the network circuit 109.

When the execution of the network transmission process S203 has ended, it is determined in Step S204 whether a stop request for the transmission, which has been issued by the decoding device, has been received. When no request has been received (“No” in the drawing), the processing will be repeated from the imaging step of Step S201. When a stop request for the transmission has been received (“Yes” in the drawing), the processing will end.

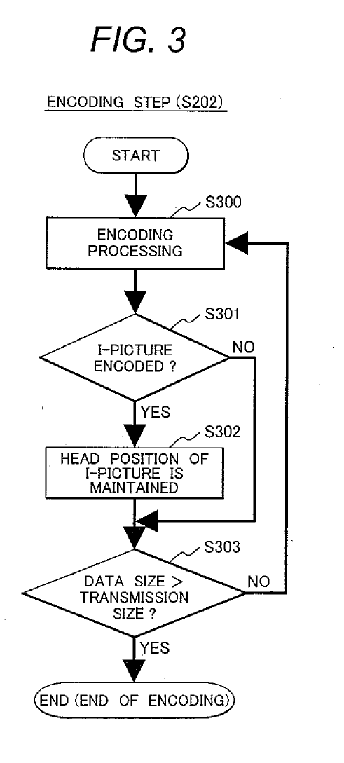

FIG. 3 illustrates a flow chart illustrating in detail the encoding step of Step S202 in Embodiment 1. Herein, it is characterized in that an underflow in the aforementioned transmission buffer is prevented.

In Step S300, the input video signal and the input audio signal, which have been created in the imaging step S201, are encoded by the video encoder circuit 105 and the audio encoder circuit 106. The encoding is performed in a picture unit. The system controller 111 determines in Step S301 whether the type of the picture, which has been encoded immediately before, is an I-picture. The determination of whether the type of the picture is the I-picture may be made based on the data indicating the type of the picture in the encoded stream, or may be made by counting the number of the pictures because the I-picture is located at the head of a GOP (Group Of Picture). When it is determined that the I-picture is encoded (“Yes” in the drawing), the system controller 111 memorizes in Step S302 the head position of the I-picture and makes a transition to Step S303.

When it is determined in Step S301 that the type of the picture, which has been encoded immediately before, is not an I-picture (“No” in the drawing), the system controller makes a transition to the processing of Step S303. The system controller 111 determines in Step S303 whether the stream data size whose encoding has ended exceeds the transmission size that has been requested by the decoding device. When the data size exceeds the requested transmission size (“Yes” in the drawing), the system controller 111 ends the encoding step of Step 202 and makes a transition to the network transmission step of Step 203. When the data size does not exceed the requested transmission size (“No” in the drawing), the system controller 111 makes a transition to Step S300 and repeats the encoding processing of the next picture. Even when the data size does not exceed the requested transmission size, the network transmission step of Step S203 is executed.

As stated above, by comparing the data size with the transmission size that is requested by a decoding device such that the data, which is greater than the latter, is accumulated in the stream buffer 108, an underflow of the data in the stream buffer 108 may be surely prevented. The transmission sizes that are requested by decoding devices are mostly within the range of approximately ten Kbytes to approximately several tens Kbytes.

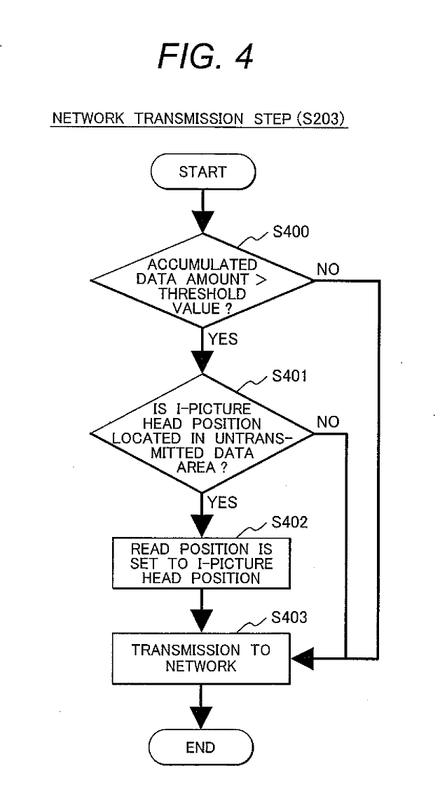

FIG. 4 illustrates a flow chart showing in detail the network transmission step of Step 203 in Embodiment 1. Herein, it is characterized in that the aforementioned delay is reduced.

The system controller 111 determines in Step S400 whether the stream data size, which has been accumulated in the stream buffer 108, exceeds a predetermined threshold value. The threshold value may be set to be an optimal value by a system designer or a user. The bit rate of the TS stream with HD video quality is generally within the range of 10 Mbps to 25 Mbps, and an encoding amount of approximately 640 Kbytes to approximately 1.6 Mbytes is created per GOP. Because one GOP is equal to 0.5 seconds, an encoding amount has to be set to be approximately 500 Kbytes if it is necessary that a delay in an encoding device is suppressed to be less than or equal to 0.5 seconds.

When it is determined in Step S400 that the data size does not exceed the predetermined threshold value (“No” in the drawing), the communication is being continued smoothly, thereby allowing for a delay to be less likely to occur. Accordingly, the system controller 111 makes a transition to Step S403 such that the network circuit 109 sequentially transmits the accumulated data to the network. When it is determined that the data size exceeds the threshold value (“Yes” in the drawing), a possibility of occurring a delay is high. Accordingly, the system controller 111 makes a transition to Step S401 to determine whether the I-picture head position, which has been memorized in Step S302 in FIG. 3, is located in the untransmitted data area. The untransmitted data area means the data area between the position at which the network circuit 109 reads the stream data that has been accumulated in the stream buffer 108 and the position at which the video-audio multiplexing circuit 107 writes the encoded data in the stream buffer 108. It is determined in Step S401 that the I-picture head position is located in the untransmitted data area (“Yes” in the drawing), the system controller 111 sets the I-picture head position to be the next read position in Step S402. Thereafter, the network circuit 109 transmits the accumulated data in the stream buffer 108 to the network in Step S 403. When it is determined that the I-picture head position is not located in the untransmitted data area (“No” in the drawing), the system controller 111 makes a transition to Step S403 such that the network circuit 109 sequentially transmits the accumulated data in the stream buffer 108 to the network.

When a plurality of the I-pictures are located in the accumulated data in the stream buffer 108, it is satisfactory that the I-picture, which has been lastly accumulated, that is, which is located at the last position on the time axis, is set to be the next read position. Thereby, the effect of reducing a delay may be made significant.

As stated above, when a delay becomes a problem because the accumulated data in the stream buffer 108 exceeds a predetermined threshold value, it is designed that the delay is reduced with the network circuit 109 skipping the read position to the I frame to transmit the accumulated data.

In the present embodiment, when the encoding step S202 illustrated in FIG. 3 and the network transmission step S203 illustrated in FIG. 4 are combined together, an underflow of data may be prevented if the accumulated data in the stream buffer 108 is less than or equal to, for example, 10 Kbytes, whereas a delay may be reduced if the accumulated data in the stream buffer 108 is greater than or equal to, for example, 500 Kbytes.

An example of reducing a delay in the real-time video and audio communication has been described above with reference to FIGS. 2 through 4, as an embodiment of the present invention. Thereby, a delay, occurring due to an external factor, such as a network environment, may be reduced without waiting time on the encoding device side. There is also an advantage that video disorder, occurring due to a delay in data reception, may be suppressed to the minimum by skipping the read position of the stream buffer 108 to the boundary of the I-picture. Further, there is an advantage that an underflow of data does not occur because it is confirmed whether the data size, which has been requested by a decoding device, is located in the stream buffer.

### Embodiment 2

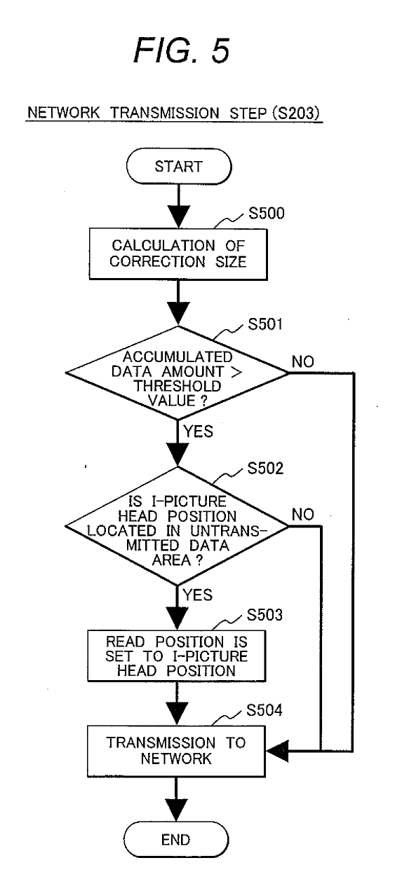

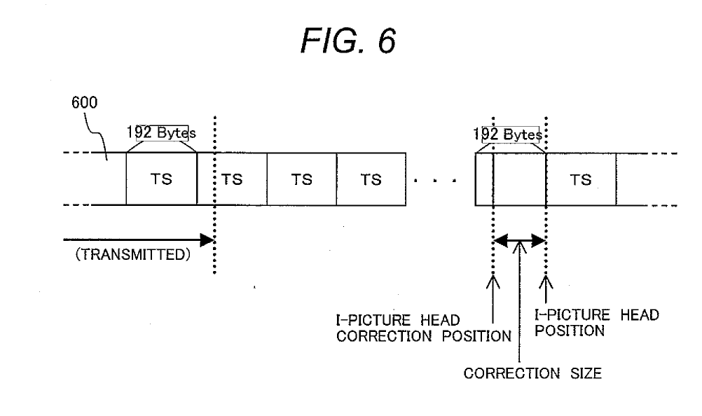

Subsequently, another method of reducing a delay in the network transmission step of S203, which is different from that in Embodiment 1, will be described with reference to FIGS. 5 and 6.

In TV phone devices or TV conference systems, an elementary stream of each of video and audio is generally transmitted to a network after being multiplexed into the TS or the PS by a multiplexing unit, such as the video-audio multiplexing circuit 107. The TS and the PS are respectively configured with continued packets with certain sizes (TS; 192 bytes, PS; 2048 bytes), and the packet sizes are unrelated to the frame sizes of video and audio.

On the decoding device side, the stream that has been packetized into the TS format or the PS format is generally separated into elementary streams of video and audio and then decoded. Accordingly, if a normal stream is not inputted to a video-audio separation circuit, normal separation processing cannot be performed depending on a decoding device, thereby possibly causing a breakdown. That is, there is a possibility that, if a stream in which the cycle of the packet boundary is not constant is inputted, the video/audio separation cannot be performed normally depending on a decoding device.

In order to make the method of reducing a delay according to Embodiment 1 effective irrespective of a decoding device, it is necessary to skip the read position in accordance with the cycle of the packet boundary.

FIG. 5 illustrates a flow chart in which a packet boundary condition is added to the processing of the network transmission step S203 in FIG. 4. In Step S500, a correction size to the packet boundary position is calculated from the stream data size and the packet size, which have been transmitted before the previous network transmission step. The meaning and the calculation method of the correction size will be described later with reference to FIG. 6. Subsequently, the system controller 111 determines in Step S501 whether the stream data size that has been accumulated in the stream buffer 108 exceeds a predetermined threshold value. The threshold value may be set to be an optimal value by a system designer or a user in the same way as Step S400 in FIG. 4. When the stream data size does not exceed the predetermined threshold value (“No” in the drawing), a delay is less likely to occur. Accordingly, the system controller 111 makes a transition to Step S504 such that the network circuit 109 sequentially transmits the accumulated data in the stream buffer 108 to the network. When the stream data size exceeds the threshold value (“Yes” in the drawing), a possibility of occurring a delay is high. Accordingly, the system controller 111 makes a transition to Step S502 to determine whether the position (hereinafter, referred to as the “I-picture head correction position”), which is determined by subtracting the correction size that has been calculated in Step S500 from the I-picture head position that has been memorized in step S302 in FIG. 3, is located in the untransmitted data area. When the I-picture head correction position is located in the untransmitted data area in Step S502 (“Yes” in the drawing), the system controller sets in Step S503 the I-picture head correction position to be the next read position and the network circuit 109 transmits in Step S504 the accumulated data in the stream buffer 108 to the network. When the I-picture head correction position is not located in the untransmitted data area in Step S502 (“No” in the drawing), the system controller 111 makes a transition to Step S504 to sequentially transmit the accumulated data in the stream buffer 108 to the network.

FIG. 6 is a view illustrating an example in which the method of calculating the correction size is applied to the TS with a time stamp. Herein, it is assumed that the packet in the area denoted with “transmitted” in the drawing was transmitted last time. The packet size of the TS with a time stamp is 192 bytes; however, the transmission size that is requested by a decoding device is irrespective of the TS packet size. Accordingly, the transmission sometimes ends in the middle of the last packet as illustrated. When the data size in the stream buffer 108 is smaller than a predetermined threshold value and a delay does not become a problem, the middle of the packet at which the transmission ended last time will be sequentially transmitted in the next transmission. Therefore, a problem of occurring a decoding error is not caused in a decoding device.

However, when the data size in the stream buffer 108 is greater than a predetermined threshold value and a delay becomes a problem, the following problem arises if the transmission is initiated with the next I-picture head position being a starting position: It is assumed that the next I-picture is located at the position denoted with “I-picture head position” in FIG. 6. The I-picture is located at the head of the packet. Accordingly, the cycle of the packet boundary is shifted from a predetermined value, thereby sometimes causing a decoding error in a decoding device.

The position at which the previous transmission ended may be founded from both the transmission size that is requested by a decoding device and the packet size. By determining the difference between the position thus found and the next packet boundary, the illustrated correction size (obliquely striped area) is determined. When the position ahead by the correction size of the I-picture head position is assumed to be the I-picture head correction position, and when the I-picture head correction position is assumed to be the starting position of the next transmission, the cycle of the packet boundary does not vary. Therefore, the aforementioned problem of occurring a decoding error may be solved. In this case, the read position at which the encoded data is read from the stream buffer 108 is to be shifted by an integral multiple of the packet size.

When the transmission size that is requested by a decoding device is always multiple sizes of the packet size, the correction size always becomes 0. However, when the transmission size that is requested by a decoding device is not multiple sizes of the packet size, the packet boundary is to be shifted. Accordingly, the system controller 111 calculates, in Step S500 in FIG. 5, the correction size at every transmission. The example in FIG. 6 has been described, taking the TS as an example; however, even for the PS and other packetized methods, a decoding error may also be prevented by calculating the correction size in the same way.

The example in which the skip of read position, which is intended to reduce a delay, is performed taking into consideration the packet boundary, has been described above with reference to FIGS. 5 and 6. The processing of reducing a delay may be normally performed by using the aforementioned method even when received by a decoding device that may break down if an irregular stream in which the packet boundary is not taken into consideration is inputted.

### Embodiment 3

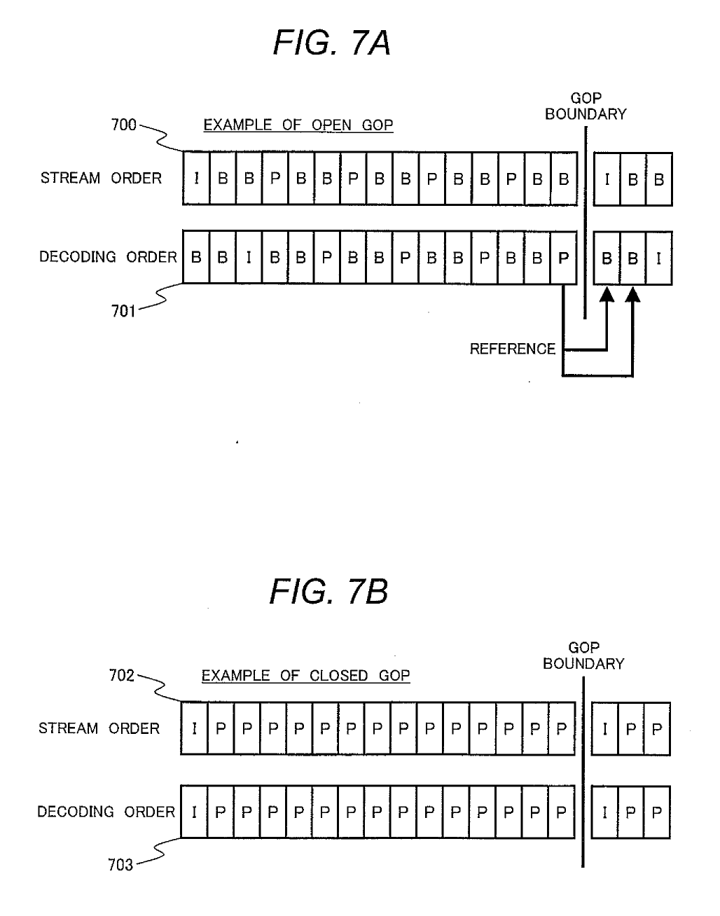

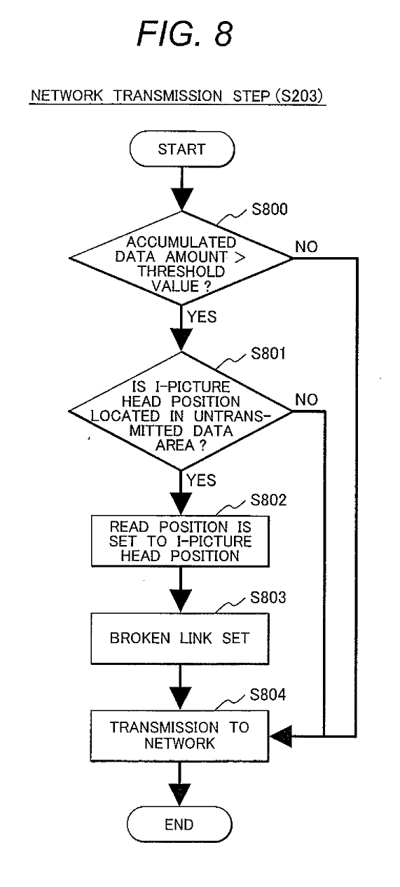

Subsequently, still another embodiment in which a decoding error may be prevented in a decoding device will be described with reference to FIGS. 7 and 8.

In the video encoding standards, such as MPEG 2 and MPEG 4 AVC/H. 264, there are two GOP structures of an Open GOP and a Closed GOP. FIG. 7A illustrates an example of an Open GOP whereas FIG. 7B illustrates that of a Closed GOP. The structure of the bit stream of an Open GOP has the sequence denoted with 700 in FIG. 7A, which is decoded in the order denoted with 701 in a decoding device that receives the stream. Each picture is shifted backwards by two pictures in the decoding but the GOP boundary is not changed. Accordingly, at the GOP boundary denoted with 701, the B-picture at the head of the rear GOP is decoded with reference to the P-picture at the foot of the immediately before GOP. That is, an Open GOP means the GOP with a B-picture that is decoded with reference to a picture of the immediately before GOP.

In general, division edit of a stream is mostly performed in a GOP unit. In the case of an Open GOP, there is a possibility that a decoding error may occur depending on a decoding device due to the aforementioned B-picture influence when the stream after the GOP boundary is intended to be decoded from the head, and hence a broken link flag is to be set. The broken link flag means a flag by which it is directed that the B-picture, which refers to the previous GOP, is neglected in an Open GOP. Accordingly, the stream in which a broken ling flag is set may communicate to a decoding device that it not necessary for a target picture to be decoded. In the case of the MPEG 2, a broken link flag may be set in the GOP header of the MPEG video layer. In the case of the MPEG 4 AVC/H. 264, a broken link flag may be set in the SEI (Supplemental Enhancement Information) in the NAL (Network Abstraction Layer) unit.

On the other hand, a closed GOP has the structure of the bit stream denoted with 702 in FIG. 7B, which is decoded in the order denoted with 703 in a decoding device that has received the stream. Each picture is shifted backwards by one picture in the decoding, but the GOP boundary is also shifted in the same way, and hence the relative relationship is not changed. Herein, for simplification of the drawing, the case where a B-picture is not present is illustrated, but a B-picture is present in certain Closed GOPs. In this case, the picture, which refers to the immediately before GOP, is not present in the second half-GOP. When the GOP structure consists of only I-pictures and P-pictures, it necessarily becomes a Closed GOP stream.

As stated above, at the position where a read position is skipped and at the position where the packet boundary is skipped, which have been illustrated in Embodiments 1 and 2, there is a possibility that a decoding error may occur on a decoding device side when the GOP, which is to be read immediately after the skip, is an Open GOP. A way to prevent the problem will be described with reference to the flow chart in FIG. 8.

FIG. 8 illustrates a flow chart showing in detail the network transmission step of Step S203 in Embodiment 3 in FIG. 8. The system controller 111 determines in Step S800 whether the stream data size accumulated in the stream buffer 108 exceeds a predetermined threshold value. The threshold value may be set to be an optimal value by a system designer or a user in the same way as that in FIG. 4. When the data size does not exceed the threshold value (“No” in the drawing), a delay is less likely to occur. Accordingly, the system controller 111 makes a transition to Step S804 such that the network circuit 109 sequentially transmits the accumulated data in the stream buffer 108 to the network. When the data size exceeds the threshold value, a possibility of occurring a delay is high. Accordingly, the system controller 111 makes a transition to Step S801 to determine whether the I-picture head position that has been memorized in Step S302 in FIG. 3 (or the I-picture head correction position) is located in the untransmitted data area. When the I-picture head position (or the I-picture head correction position) is located in the untransmitted data area (“Yes” in the drawing) in Step S801, the system controller 111 sets in Step S802 the I-picture head position (or the I-picture head correction position) to be the next read position. Subsequently, the system controller 111 sets the aforementioned broken link flag in Step S803, and makes a transition to Step S804. In Step S804, the accumulated data is read from the read position and transmitted to the network. When the I-picture head position (or the I-picture head correction position) is not located in the untransmitted data area in Step S801, the system controller 111 makes a transition to Step S804 such that the network circuit 109 sequentially transmits the accumulated data to the network.

The method of setting a broken link flag according to Embodiment 3 has been described above with reference to FIGS. 7A, 7B, and 8. Thereby, a decoding error may be prevented from occurring on the decoding device side even when the position at which the read position has been skipped to reduce a delay is an Open GOP.

### Embodiment 4

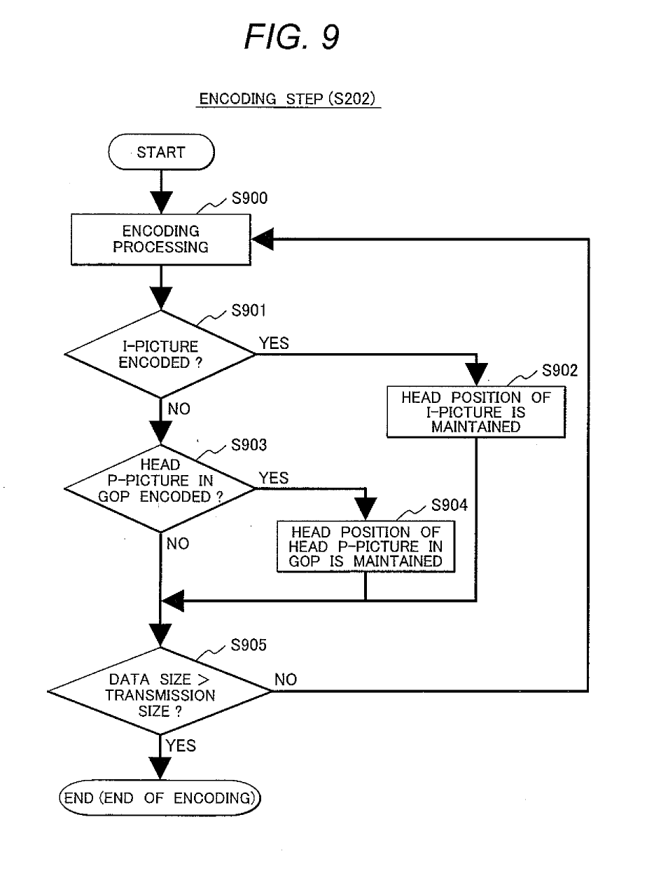

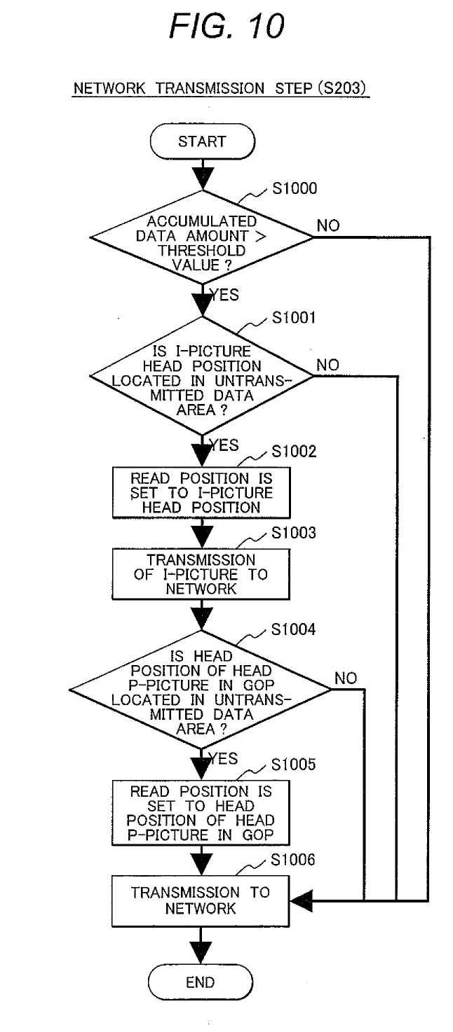

Subsequently, another embodiment in which a decoding error may be prevented in a decoding device will be described with reference to FIGS. 9 and 10.

In Embodiment 3, a decoding error after the read position has been skipped may be prevented by setting a broken link flag; however, it is necessary to edit the encoded stream immediately before the transmission, and hence the burden of the encoding device becomes slightly large. Accordingly, in Embodiment 4, when a picture whose decoding is unnecessary is present after the read position has been skipped to the I-picture head position (or the I-picture head correction position), the read position will be further skipped.

FIG. 9 illustrates a flow chart showing in detail the encoding step of Step S202 in Embodiment 4. In Step S900, the video encoder circuit 105 codes an input moving image which has been created in the imaging step S201. The encoding is performed in a picture unit. The system controller 111 determines in Step S901 whether the type of the picture, which has been encoded immediately before, is an I-picture. When it is determined that the picture is an I-picture (“Yes” in the drawing), the system controller memorizes in Step S902 the I-picture head position and makes a transition to Step S905. When it is determined in Step S901 that the picture, which has been encoded immediately before, is not an I-picture (“No” in the drawing), the system controller makes a transition to the processing of Step S903. The system controller 111 determines in Step S903 whether the type of the picture, which has been encoded immediately before, is the head P-picture in the GOP. When it is determined that the picture is the head P-picture in the GOP (“Yes” in the drawing), the system controller 111 memorizes in Step S904 the head position of the head P-picture in the GOP, and makes a transition to Step S905. When it is determined that the type of the picture, which has been encoded immediately before in Step S903, is not the head P-picture in the GOP (“No” in the drawing), the system controller 111 makes a transition to the processing of Step S905. The system controller 111 determines in Step S905 whether the stream data whose encoding has ended exceeds the transmission size that has been requested by the decoding device. When the data size exceeds the requested transmission size (“Yes” in the drawing), the system controller 111 ends the encoding step of S202 and makes a transition to the processing of the network transmission step of S203. When the data size does not exceed the requested transmission size (“No” in the drawing), the system controller 111 makes a transition to Step S900 and repeats from the encoding processing of the picture.

FIG. 10 illustrates a flow chart showing in detail the network transmission step of Step S203 in Embodiment 4. The system controller 111 determines in Step S1000 whether the stream data size accumulated in the stream buffer 108 has exceeded a predetermined threshold value. The threshold value may be set to be an optimal value by a system designer or a user in the same way as that in FIG. 4. When the data size does not exceed the threshold value (“No” in the drawing), a delay is less likely to occur. Accordingly, the system controller 111 makes a transition to Step S1006 such that the accumulated data are sequentially transmitted to the network. When the data size exceeds the threshold value (“Yes” in the drawing), a possibility of occurring a delay is high. Accordingly, the system controller 111 makes a transition to Step S1001 to determine whether the I-picture head position that has been memorized in Step S 902 in FIG. 9 (or the I-picture head correction position) is located in the untransmitted data area. When the I-picture head position (or the I-picture head correction position) is located in the untransmitted data area (“Yes” in the drawing), the system controller 111 sets the I-picture head position (or the I-picture head correction position) to be the next read position in Step S1002 and makes a transition to Step S1003. In Step S1003, the network circuit 109 reads the accumulated data from the stream buffer 108 and transmit only the I-pictures to the network. Subsequently, the system controller 111 determines in Step S1004 whether the head position of the head P-picture in the GOP that has been memorized in Step S904 in FIG. 9 (or the head correction position of the head P-picture in the GOP) is located in the untransmitted data area. When the head P-picture in the GOP (or the head correction position of the head P-picture in the GOP) is located in the untransmitted data area (“Yes” in the drawing), the system controller 111 sets in Step S1005 the head position of the head P-picture in the GOP (or the head correction position of the head P-picture in the GOP) to be the next read position, and the network circuit 109 transmits in Step S1006 the accumulated data in the stream buffer 108 to the network. Therefore, decoding may be performed with a B-picture, if located at the head in the GOP, being neglected, allowing for a decoding error in the aforementioned OPEN GOP to be prevented.

When the I-picture head position (or the I-picture head correction position) is not located in the untransmitted data area in Step S1001 (“No” in the drawing), the system controller 111 makes a transition to Step S1006 such that the network circuit 109 sequentially transmits the accumulated data in the stream buffer 108 to the network. When the head P-picture position in the GOP (or the head correction position of the head P-picture in the GOP) is not located in the untransmitted data area in Step S1004 (“No in the drawing), the system controller 111 makes a transition to Step S1006 such that the network circuit 109 sequentially transmits the accumulated data in the stream buffer 108 to the network.

The method of preventing a decoding error after skipping to an I-picture in Embodiment 4 has been described above with reference to FIGS. 9 and 10. Thereby, a decoding error may be prevented from occurring on the decoding device side even when the position at which the read position has been skipped in order to reduce a delay is located in an Open GOP. Further, because it is not necessary to correct the encoded stream, which is different from Embodiment 3, the burden of an encoding device does not become large.

The system configurations and process procedures described in Embodiments 1 through 4 are intended only to be illustrative of the present invention, and those skilled in the art will recognize that different configurations, different process procedures, and combination of each Embodiment may be made in the various features and elements of the invention without departing from the scope of the invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A device for encoding a moving image, comprising:
an imaging unit that generates the moving image by shooting a subject;
an encoder circuit that encodes data of the moving image;
a stream buffer that accumulates the encoded data of the moving image that is supplied from the encoder circuit;
a network circuit that transmits the encoded data of the moving image, which has been accumulated in the stream buffer, to a network; and
a system controller that operatively controls the device for encoding a moving image, wherein, when an accumulated amount of the encoded data, which has been accumulated in the stream buffer, is greater than or equal to a predetermined threshold value, the system controller controls the device for encoding a moving image such that a read position at which the encoded data is to be read from the stream buffer is advanced forward on the time axis.

2. The device for encoding a moving image according to claim 1, wherein, when the accumulated amount of the encoded data, which has been accumulated in the stream buffer, is greater than or equal to the predetermined threshold value and when encoded data of an I picture is present in the encoded data, which has been accumulated in the stream buffer, the system controller controls the device for encoding a moving image such that the read position at which the encoded data is to be read from the stream buffer is advanced to the head position of the most backward I picture on the time axis.

3. A method of encoding a moving image, comprising:
an imaging step that creates the moving image by shooting a subject;
an encoding step that encodes data of the moving image;
an accumulation step that accumulates the encoded data of the moving image that has been created in the encoding step;
a communication step that transmits the encoded data of the moving image, which has been accumulated in the accumulation step, to a network; and
a system control step that controls the encoding step, the accumulation step, and the communication step, wherein the system control step includes an accumulated amount determination step that determines whether an accumulated amount of the encoded data of the moving image, which has been accumulated in the accumulation step, is greater than or equal to a predetermined threshold value, and wherein, when it is determined that an accumulated amount of the encoded data of the moving image, which has been accumulated in the accumulation step, is greater than or equal to a predetermined threshold value as a result of the determination in the accumulated amount determination step, the system control step controls the accumulation step such that a read position at which the encoded data is to be read from the accumulation step is advanced forward on the time axis.

4. The method of encoding a moving image according to claim 3, wherein, when the accumulated amount of the encoded data, which has been accumulated in the stream buffer, is greater than or equal to the predetermined threshold value and when encoded data of an I picture is present in the encoded data, which has been accumulated in the stream buffer, the system control step controls the accumulation step such that the read position at which the encoded data is to be read from the accumulation step is advanced to the head position of the most backward I picture on the time axis.

5. The device for encoding a moving image according to claim 1, wherein, when the accumulated amount of the encoded data, which has been accumulated in the stream buffer, is greater than or equal to the predetermined threshold value, the system controller controls the device for encoding a moving image such that the read position at which the encoded data is to be read from the stream buffer is advanced by an integral multiple of a stream packet size.

6. The device for encoding a moving image according to claim 2, wherein, when the accumulated amount of the encoded data, which has been accumulated in the stream buffer, is greater than or equal to the predetermined threshold value, the system controller controls the device for encoding a moving image such that a broken link flag is set in the encoded data stream.

7. The device for encoding a moving image according to claim 2, wherein, when the accumulated amount of the encoded data, which has been accumulated in the stream buffer, is greater than or equal to a threshold value, the system controller controls the device for encoding a moving image such that the read position is advanced to the next P-picture head position.
